(19) United States
(12) Patent Application Publication
(10) Pub. No.: US 2019/0043103 A1
(43) Pub. Date: Feb. 7, 2019

(54) Systems and Methods for Use in Facilitating Payment Account Transactions

(71) Applicant: MASTERCARD INTERNATIONAL INCORPORATED, Purchase, NY (US)

(72) Inventors: Gerardo De Las Heras, O'Fallon, MO (US); Sandra K. Bequette, Wildwood, MO (US); Craig Louis Prior, St. Louis, MO (US); Kimberly Ann Schrey, Labadie, MO (US); Nicole A. Zavradinos, St. Louis, MO (US)

(21) Appl. No.: 15/668,926

(22) Filed: Aug. 4, 2017

(51) Int. Cl. G06Q 30/06; G06Q 20/40

(52) U.S. Cl. CPC G06Q 30/0601; G06Q 20/4014

(57) ABSTRACT

Systems and methods are provided for facilitating payment account transactions for products based on conditions associated with the products to thereby allow for replenishing the products when needed. One exemplary method includes identifying a product stage, and soliciting, from a consumer, an identity of a product to be associated with the product stage and a parameter of the product. The method also includes compiling a product stage profile for the product stage, and receiving a message from the product stage where the message includes the identifier of the product stage and a condition of the product at the product stage. The method further includes retrieving a replenishment rule for the product based on the identity of the product stage, determining whether a product purchase is implicated by the condition based on the replenishment rule, and facilitating a transaction for purchase of the product from a merchant.

### FIELD

The present disclosure generally relates to systems and methods for use in facilitating payment account transactions, and in particular, to systems and methods for use in facilitating payment account transactions for products based on conditions associated with the products and related to replenishment of the products at consumer premises.

### BACKGROUND

This section provides background information related to the present disclosure which is not necessarily prior art.

Consumers are known to use payment accounts to fund transactions for different types of products (e.g., goods and services, etc.) from different merchants. Once purchased, the products are used by the consumers, or persons associated with the consumers, until they are depleted. And, once depleted, the consumers return to the merchants to purchase additional products. Certain products, for example, milk, are depleted based on certain time intervals and may be subject to recurring transactions, such that the milk is purchased by the consumers on a weekly basis (without regard to the actual state/status of the products).

Various different reorder platforms are available to consumers to order and/or reorder products from merchants. For example, the Amazon® Dash Button (found at www.amazon.com) is a button specifically associated to a particular product and positioned at a consumer's house (where the consumer then purchases separate buttons to associate with different desired products). The consumer need only press the button to order the associated product, including, for example, toilet paper, soap, soda, coffee, batteries, etc., to name a few, whereby the product is ordered and delivered to the consumer's home (where the consumer monitors use of the product and determines when to order the product). The product may further be automatically ordered, through Amazon® Dash Replenishment (also found at www.amazon.com), based on status, as reported by one or more connected devices that use the product (e.g., a printer indicating that an ink cartridge is low, thereby directing reorder; etc.). A similar feature is available from Fresh Direct, where a consumer can add products to a list and then order (or reorder) them all at once. In so doing, the consumer either scans the product's barcode or says the product name into a microphone. As with the Amazon® Dash Button, the consumer monitors use of the various products and determines when to add them to the list.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating payment account transactions based on one or more conditions of products, as determined by product stages associated with the products;

FIG. 2 is a block diagram of a computing device that may be used in the exemplary system of FIG. 1;

FIG. 3 is a flow diagram of an exemplary method, which may be implemented in connection with the system of FIG. 1, for facilitating a payment account transaction for a product based on one or more conditions of the product, as determined by a product stage associated with the product; and

FIGS. 4-8 are exemplary interfaces that may be presented to a consumer for use in registering a product stage to a replenishment engine, and which may be used in the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Various merchants offer products for sale to consumers, and the consumers purchase the products, for example, through payment accounts. When products of certain types are spent and/or depleted, the consumers often return to the merchants to purchase additional products. Further, the products may be subject to one or more replenishment schemes, which may require consumer input(s) to identify the desired schemes and/or which may be based on connectivity of devices that use the products. Uniquely, the systems and methods herein provide product stages for products, which are agnostic in nature and may be programmed to any particular/desired product, whereby the product stages provide one or more conditions associated with the products that may facilitate and/or indicate replenishment of the products through purchase transactions for the products. In particular, for example, a product stage (comprising a physical device) may be positioned at a consumer's premises, in a location at which a product (or multiple products) can then be stored, for example, on the product stage. Through one or more sensors included in and/or associated with the product stage, the product stage is able to evaluate a condition of the product (once registered for the product) and indicate to a replenishment engine to purchase the product, when the condition of the product indicates that the product is in need of replenishment. In this manner, the product stage may be used to generally automatically identify a replenishment need for a product (without direct monitoring by a user of the product), while also providing a flexible and efficient manner of actually determining when to replenish and not replenish the product based on the actual condition of the product, and not relying, solely, for example, on an expected time intervals for use/depletion of the product, manual evaluation of the product, etc.

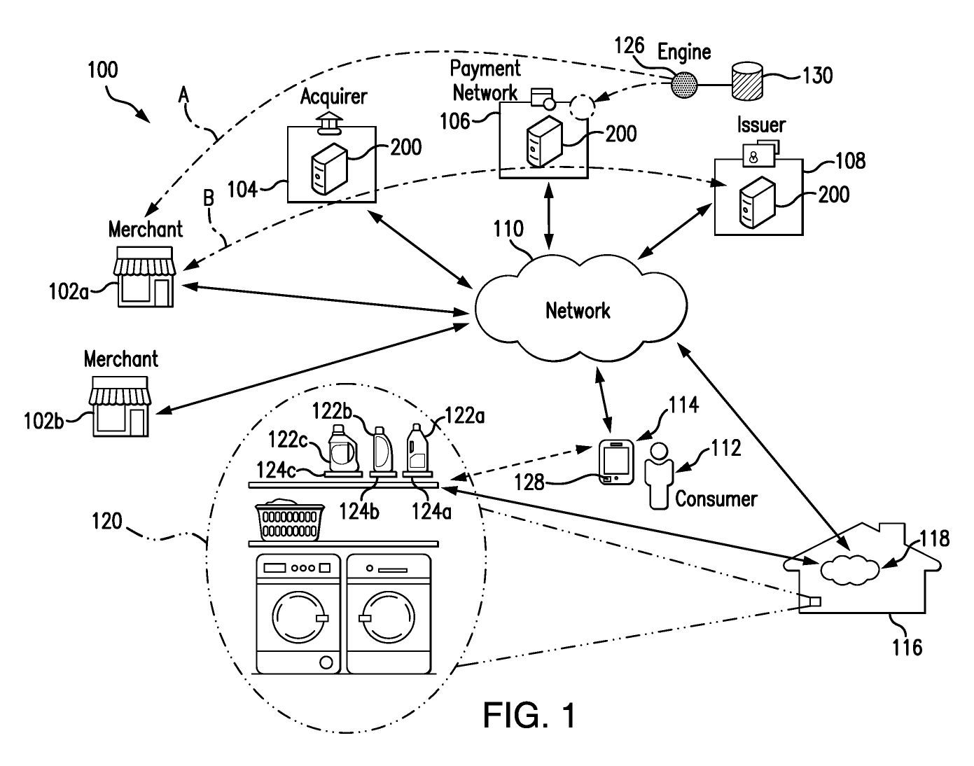

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, inclusion and/or implementation of product stages in the system 100, etc.

The system 100 generally includes two merchants 102a-b, an acquirer 104 associated with each of the merchants 102a-b, a payment network 106, and an issuer 108 configured to issue payment accounts (or other accounts) to consumers, each of which is coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between one or more of the merchants 102a-b, the payment network 106, and a consumer 112 (or, more specifically, a communication device 114 associated with the consumer 112), etc.

The merchants 102a-b are generally provided to offer products (e.g., goods and/or services, etc.) for sale to consumers in the system 100, including the consumer 112. The merchants 102a-b may offer the products for sale in physical locations or through virtual locations (e.g., websites, etc.), as desired. The products include, at least, certain products which are of limited use and/or are depleted by the consumers. For example, a detergent product may be purchase by the consumer 112, and then used until depleted (whereupon more detergent product is needed). Similarly, a dog food product may be purchased by the consumer 112 and then consumed by a dog of the consumer 112 until depleted (whereupon more dog food product is needed).

Also in the system 100, the consumer 112, in general, is associated with a payment account issued by the issuer 108. The payment account, in turn, is associated with payment account credentials (e.g., a primary account number (PAN), an expiration date, a card verification code (CVC), a token, etc.). The consumer 112 is further associated with the communication device 114, which may include a smartphone, tablet, laptop, desktop, or other communication device (although, often, a portable communication device.), etc. In at least one embodiment, the communication device 114 includes a transaction application, which may include, for example, a virtual wallet (e.g., Masterpass® from MasterCard, Apple Pay® from Apple, Samsung Pay® from Samsung, etc.), etc.

With continued reference to FIG. 1, the system 100 includes a premises 116, which may include, for example, a residence, a business, or other suitable building, structure or property, etc. In this exemplary embodiment, the premises 116 includes a residential home, owned by the consumer 112 and/or in which the consumer 112 resides. Further, in this exemplary embodiment, the premises 116 includes a network 118, which generally includes a local area network (LAN) that is provided at the premises 116, for example, by a wireless router (not shown) located at and/or within the premises 116. The network 118 may have limited range, whereby only devices within range of the network 118 (e.g., located within the premises, or proximate to the premises 116, etc.) are able to be coupled to and/or to communicate therethrough. As indicated by the solid arrowed line, the network 118 is further coupled to and/or in communication with the network 110. In general, the network 118 is provided to support communication among other parts illustrated in FIG. 1 and those included at the premises 116, as describe further below.

In the exemplary embodiment, the premises 116 includes multiple rooms, each including various different products purchased by the consumer 112 and placed within the premises 116. For example, the premises 116 may include toilet paper products in a bathroom, or milk products in a kitchen, or laundry detergent in a laundry room (with each of the exemplary products being of a type that may be used up or depleted). For purposes of illustration in the following discussion, the laundry room, and more specifically, a part of the laundry room, is shown in detail in FIG. 1 in the dotted circle, referenced 120. The laundry room 120 is within the range of the network 118, and, as is conventional, includes a washing machine and a dryer. The laundry room 120 further includes products 122a-b, which are used in connection with operation of the washing machine and/or the dryer. Specially, the laundry room 120 is illustrated as including a fabric softer product 122a, a stain remover product 122b, and a detergent product 122c. It should be appreciated that other products may be included in the laundry room 120 as desired, and that other rooms in the premises 116 (or other locations associated with the premises 116), or other premises, and/or other products maybe used and/or addressed as described herein in other system embodiments (and still be consistent with the description herein).

Further, while only two merchants 102a-b, one acquirer 104, one payment network 106, one issuer 108, and one premises 116 are illustrated in FIG. 1, it should be appreciated that any number of these parts may be included in the system 100, or may be included as a part of systems in other embodiments, consistent with the present disclosure. Likewise, it should be appreciated that the system 100 and other system embodiments will generally include multiple consumers and/or communication devices, as well as numerous products within the premises 116 (e.g., in various different rooms of the premises 116, etc.), etc.

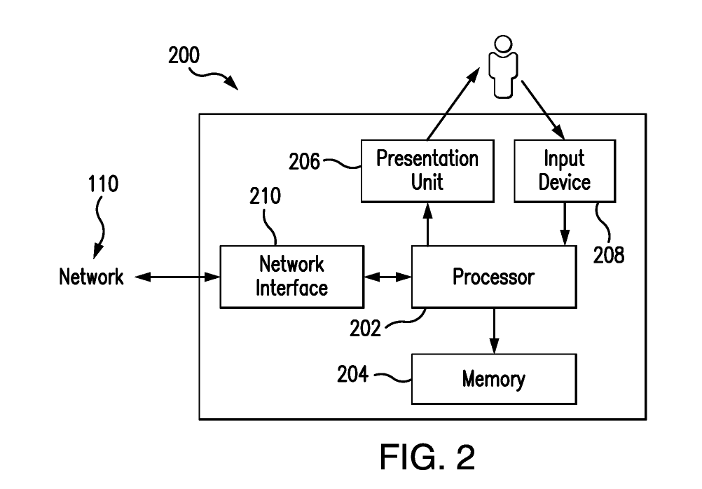

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the acquirer 104, the payment network 106, and the issuer 108 are illustrated as including, or being implemented in, computing device 200, coupled to (and in communication with) the network 110. In addition, the merchants 102a-b may be considered as including and/or being implemented in at least one computing device consistent with computing device 200. Further, the communication device 114 associated with consumer 112 can also be considered a computing device consistent with computing device 200 for purposes of the description herein. With that said, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, product descriptions and related information, replenishment rules (or preferences), payment account credentials, product stage profiles, consumer profiles, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and that is in communication with) the processor 202 (however, it should be appreciated that the computing device 200 could include output devices other than the presentation unit 206, etc.). The presentation unit 206 outputs information (e.g., offers from the merchants 102a-b, products associated with product stages, transaction requests, etc.), visually, for example, to a user of the computing device 200, such as the consumer 112 in the system 100 and/or users associated with one or more of the merchants 102a-b; etc. And, various interfaces (e.g., as defined by network-based applications such as application 128, as defined by websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, inputs by the consumer 112 on his/her communication device 114 in response to solicitations from the application 128, as further described below. The input device 208 may include a single input device or multiple input devices. The input device 208 is coupled to (and is in communication with) the processor 202 and may include, for example, one or more of a keyboard, a pointing device, a mouse, a stylus, a camera, a barcode scanner, a QR code scanner, a sensor, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to one or more different networks, including the network 110 and/or the network 118. Further, in some exemplary embodiments, the computing device 200 includes the processor 202 and one or more network interfaces incorporated into or with the processor 202. In at least one embodiment, which includes both master and subordinate computing devices, the network interface 210 in the corresponding devices may provide coupling and/or communication therebetween (e.g. via ZigBee, Bluetooth® (e.g., Bluetooth® Low Energy (BLE), etc.), Z-wave®, etc.) in the absence of a separate network (e.g., the network 110 and/or network 118, etc.).

Referring again to FIG. 1, the system 100 includes multiple product stages 124a-c, each positioned at the premises 116 and disposed so that one of the products 122a-c may be positioned on one of the product stages 124a-c. Each of the product stages 124a-c is generally consistent with the computing device 200, in that each includes one or more sensors (broadly, input devices 208, etc.) configured, by executable instructions, to determine and/or identify a condition of the associated product 122, such as for example, weight (e.g., via weight sensors, etc.), presence of product material within the associated product 122 (e.g., via imaging devices, etc.), relative amount of product material remaining in a container, number of products remaining, etc.

Other sensors, or input devices 208, may also (or alternatively) be included in the product stages 124a-c in the system 100, or in product stages in other embodiments, to detect and/or sense one or more conditions of the associated products 122a-c (or of other products). For example, capacitance sensors may be used to identify product contents within containers, and may be used in connection with weight sensors to provide indications of when the product contents are depleted (or depleted to a particular level, etc.) (e.g., to determine relative amounts of product remaining in the containers, etc.). As still another example, positioning sensors may be used to allow for determining presence (or absence) of multiple products on a tray/pad of one of the product stages 124a-c (and located at particular locations on the tray/pad, where each of the particular locations may be associated with a sensor). In this example, the tray/pad may be labeled so that the product is replaced (e.g., when a particular number of products are still present on the tray/pad, etc.) in relatively the same space on the tray/pad that it was placed on when originally set up.

In addition in the system 100, the product stages 124a-c each include a network interface (e.g., network interface 210, etc.), which is configured to communicate with the communication device 114 of the consumer 112 (directly, or via network 118, for example) and also with a replenishment engine 126 of the system 100 (via the network 110 and/or the network 118). In at least one embodiment, a product stage may include multiple network interfaces (e.g., multiple ones of network interface 210, etc.), whereby the product stage utilizes one network interface to communicate via the network 118 to the replenishment engine 126, while utilizing a different network interface to communicate with other product stages (as described with reference to the master and subordinate product stage relationship below).

It should be appreciated that the product stages 124a-c may vary in size, shape, construction, and features to account, for example, for different positions in the premises (e.g., laundry shelves versus refrigerator shelves, etc.), for different aspects of the products to be associated therewith (e.g., to account for sizes, shapes, contents (e.g., liquid contents verses solid contents, etc.), environmental constraints, etc. of the products), to account for different numbers of products being associated with and/or positioned on the stages 124a-c, etc.

Further, in this exemplary embodiment, the product stages 124a-c may be configured with (or may be associated with) a master and subordinate relationship therebetween. In particular, for example, the product stage 124a may be a master product stage, and product stages 124b-c may be subordinate stages, in that the subordinate stages 124b-c are coupled to and/or communicate with the product stage 124a (to operate as described herein), rather than the network 118 (or even the network 110). As such, in this example, the master product stage 124a is configured as the conduit for communication with the product stages 124b-c by other devices, as described below.

It should be appreciated that various configurations of the product stages 124a-c and/or other product stages may be employed in this and other embodiments, for example, to enable efficient communication to/for the stages.

In connection therewith, the master product stage 124a may include a 9V battery power source (or other suitable battery power source) and/or a wired power connection (e.g., via a power cord and adaptor, etc.), for example, to provide sufficient power to accommodate any sensors associated therewith, and to accommodate WiFi communication, via the network interface 210, with the network 118 and/or, via a different network interface 210, with the network 110 (and Bluetooth® and/or ZigBee communication with the subordinate product stages 124b-c). The subordinate product stages 124b-c may then include a coin cell battery power source (or other suitable battery power source), for example, to provide sufficient power to accommodate any sensors associated therewith, and to accommodate Bluetooth® and/or ZigBee communication, via the network interface 210, with the other ones of the product stages 124a-c (e.g., via a mesh network, etc.). Moreover, the subordinate product stages 124b-c (by use of Bluetooth® and/or ZigBee communication) may exhibit a sleep mode, and then an awake mode to communicate a product condition (e.g., when a product is placed thereon or removed therefrom, or at a predefined interval (e.g., one minute, one hour, etc.); etc.), whereby, for example, they may be able to operate for a substantial duration, such as, for example, up to about two years on the coin cell batteries. The product stages 124a-c may further be configured to work offline and enable transmission at specific cycles or conditions to conserve energy/power, as desired.

Notwithstanding from the master-subordinate relationship, the product stages 124a-c may include and/or be associated with a variety of different power sources (including the above or variations of the above) to support the sensors included therein, based on the network interfaces included therein, and/or to provide a specific operational period (e.g., based on power source life, etc.), etc.

As a specific example of a product stage, and consistent with the computing device 200, the processor 202 may include (without limitation) an Elegoo UNO R3 board (ATmega328P ATmega16U2), compatible with Arduino UNO R3; the input device 208 may include (without limitation) two Force Sensing Resistors (FSRs), each being 1.5 inch square in size and capable of sensing 1 ounce to 22 pounds (and having two leads and a 0.1 inch spacing); and the network device/interface 210 may include (without limitation) a Kedsum Arduino Wireless Bluetooth Transceiver Module Slave (four pin serial and DuPont® Cable) and/or a HiLetgo New Version Node (MCU LUA WiFi Internet ESP8266). The product stage may further include a housing, a tray, and/or a pad which supports, encloses, and/or partially encloses the above, for use in its intended environment (e.g., for receiving a product thereon, etc.).

With continued reference to FIG. 1, the system 100 includes the replenishment engine 126, which is specifically configured, by computer-executable instructions, to perform one or more of the operations described herein. In the illustrated embodiment, the replenishment engine 126 is provided as a separate part of the system 100 and in communication with the payment network 106, for example. As such, the replenishment engine 126 may be considered a computing device consistent with computing device 200. However, as indicated by the dotted line in FIG. 1, the replenishment engine 126 may be incorporated, partly or entirely, into the payment network 106 in the illustrated system 100. Further, it should be appreciated that the replenishment engine 126 may be associated with, or incorporated with, other parts of the system 100, in whole, or in part, in other embodiments. In connection therewith, for example, the replenishment engine 126 may be associated with, or incorporated with, such other parts of the system 100 by way of a companion application. Specifically, in the illustrated embodiment, the communication device 114 associated with the consumer 112 includes replenishment application 128 (i.e., a network-based application), which configures the communication device 114 to, for example, interact with the replenishment engine 126 and/or display interfaces to the consumer 112, at the communication device 114, consistent with the operations described herein.

In addition to the replenishment engine 126, the system 100 includes a data structure 130, which is coupled to (and is in communication with) the replenishment engine 126 and/or the replenishment application 128. The data structure 130 includes, at least, consumer profiles, which, in turn, include one or more product stage profiles. The consumer and stage profiles are described in more detail below. The data structure 130 may be a standalone part of the system 100, as shown in FIG. 1, or it may be included in memory of the replenishment engine 126 (e.g., memory 204, etc.) or elsewhere in the system 100. Likewise, it should be understood that the data structure 130 may be divided into separate structures, stored at separate parts of the system 100, and accessed from separate locations.

In general in the system 100, the replenishment engine 126 is configured, for example, to register consumers (e.g., the consumer 112, etc.) and/or product stages (e.g., the product stages 124a-c) and to facilitate payment account transactions for the consumers based on conditions of products 122a-b, as indicated by the product stages 124a-c (and rules/preferences associated with the conditions).

In particular, the consumer 112 initially installs, activates and/or registers the replenishment application 128 at his/her communication device 114. Upon installation, the communication device 114 is configured to solicit from the consumer 112, via one or more interfaces, the consumer's name, billing address, shipping address, preferences, etc., as well as payment account credentials (e.g., PAN, expiration date, card verification code, etc.) for the consumer's payment account (e.g., directly from the consumer 112, from a virtual wallet at the consumer's communication device 114, etc.). Once the necessary information is provided by the consumer 112, the communication device 114 is configured (by the replenishment application 128) to provide the same to the replenishment engine 126, which, in turn, is configured to generate a profile for the consumer 112 (i.e., a consumer profile) and store that consumer profile in data structure 130 (e.g., in memory 204 associated therewith, etc.). Once registered, the consumer 112 may be able to register other users often present at the premises 116 (e.g., a spouse, a child, a sibling, a friend, a roommate, etc.), whereby the other users may then be able to interact with the product stages 124a-c and/or replenishment engine 126, for example, to purchase products, etc. when rules associated with purchases of such products indicate that purchase options/requests for the products are to be transmitted to the consumer 112 (as will be described more below). In so doing, the consumer 112 may designate the other users by phone number or email address, etc., whereupon the replenishment engine 126 may then transmit an invitation to the other users to download the replenishment application 128 (where the other users then proceed through the above registration process, or a reduced version of same), or otherwise. That said, in various embodiments, the consumer 112 may limit certain ones of the stages 124a-c, and corresponding products, to certain ones of the other users (e.g., a child may be limited to receiving options for product purchases for particular ones of the stages and/or particular products, etc.).

Subsequently, based on use, as described below, the consumer profile for the consumer 112 may include historical data about prior replenishments performed for the consumer 112 by the replenishment engine 126 (e.g., products purchased, costs, delivery days, etc.).

In association with the profile, the consumer 112 may purchase (or otherwise obtain) the product stages 124a-c, to be used at the premises 116 (in the laundry room 120). Because, in this exemplary embodiment, the product stages 124a-c, in general, are product agnostic, the consumer 112 is able to obtain the product stages 124a-c and then use them for (and/or in association with) any product consistent with the product stages 124a-c (e.g., based on size, weight, sensitivity, dimensions, etc.). When the consumer 112 selects product 122a, for example, to be associated with the product stage 124a, the consumer 112 positions the product stage 124a at an appropriate location at the premises 116 (e.g., on a laundry room shelf, etc.), and then launches the replenishment application 128, at the communication device 114, to recognize and register the product stage 124a. In turn, the communication device 114 is configured (by the replenishment application 128) to identify and/or detect the product stage 124a (e.g., by connecting to the product stage 124a, via the network interface 210, etc.). In response, the product stage 124a is configured to provide at least one identifier associated with the product stage 124a to the communication device 114, via the replenishment application 128 (e.g., a media access control (MAC) address, Electronic Serial Number (ESN), device name, number, etc.).

Next, the communication device 114, via the replenishment application 128 (through one or more interfaces), is configured to solicit from the consumer 112 an identity (e.g., product name, product shop keeper unit (SKU), etc.) of the product, a name of the product stage 124a (e.g., “detergent stage,” “milk stage,” etc.), and one or more parameters such as: information regarding the product 122a (e.g., preferred product brand, product size (e.g., number of ounces, number of pounds, number of products, etc.); typical use of the product 122a; conditions for when purchasing the product 122a is needed (e.g., a threshold amount of when a new product 122a is to be purchased, etc.), etc.) and/or the underlying purchase transaction for the product 122a (e.g., time/date, payment account credentials, preferred merchant identification, acceptable prices and/or costs (or ranges of the same), instructions for automatic purchases of the product 122a (e.g., an automatic replenishment, or auto-replenishment, service, etc.), instructions for approval required purchases of the product 122a (e.g., via alerts to the consumer 112 at the communication device 114, etc.), number of products to reorder, etc.); etc.

The consumer 112, in turn, responds to the solicitation by providing the appropriate product identity, stage name (as desired), and parameters (e.g., by taking a photo of the product 122a, entering purchase rules, etc.). For example, in connection with providing the identity of the product and/or the desired parameters, the consumer 112 may be instructed to point the communication device's camera at the product 122a, whereupon the communication device 114 is configured to capture an image of the product 122a (and a name and/or parameters associated therewith (e.g., a barcode, etc.)), and/or the consumer 112 may be instructed to place the product 122a on the product stage 124a or otherwise interact with the product stage 124a, whereupon the product stage 124a is configured to provide parameters to the communication device 114, etc. In connection therewith, the consumer 112 may normalize, or train, the product stage 124a for the particular product 122a to be associated therewith, for example, by placing a new version (e.g., full, unused, unopened, etc.) of the product 122a on the product stage 124a to create a baseline condition (broadly, a parameter), or frame of reference for subsequent conditions, for the product 122a to the product stage 124a for use by the product stage 124a in connection with a condition of the product 122a, etc. The communication device 114 is further configured to then transmit the received product identity, stage name, and parameters to the replenishment engine 126.

In turn, upon receiving the product identifier, stage name, and/or parameters, the replenishment engine 126 is configured to compile a stage profile for the product stage 124a, which includes the product identifier for the corresponding product 122a, stage name, and/or parameters, as well as the communication path for the product stage 124a (e.g., the MAC address, etc.).

Then, based on the product identifier for the product 122a and/or parameters solicited from the consumer 112 and included in the stage profile, the replenishment engine 126 is configured to compile purchase rules for the product stage 124a. The rules, in general, include criteria for a replenishment transaction of the product 122a, based on a condition of the product 122a (e.g., purchase fabric softener when weight falls below 1 lb., purchase detergent when 10% remains, etc.), as described in more detail below. The rules may also include purchase settings such as, for example, automatic purchases for certain ones of the product stages 124a-c, for certain ones of the products 122a-c (e.g., via an auto-replenishment service facilitated through the replenishment engine 126 and/or provided by a third-party provider, etc.); approval required purchases for certain ones of the product stages 124a-c (e.g., via alerts from the replenishment engine 126 to the consumer 112 at the communication device 114, etc.), for certain ones of the products 122a-c; etc. The rules may further be compiled by the replenishment engine 126 and/or otherwise based on, for example, thresholds, consumption rates, estimated delivery intervals, etc.

Thereafter, in one or more embodiments, the communication device 114 and/or the replenishment application 128 may be omitted from communications between the product stage 124a and/or the replenishment engine 126 (as desired). As such, the product stage 124a may communicate directly with the replenishment engine 126 (although this is not required in all embodiments).

With that said, in operation, the product stage 124a is configured to detect one or more conditions of the product 122a and to transmit the condition or conditions to the replenishment engine 126, at one or more regular or irregular intervals (e.g., as an event, etc.). In turn, the replenishment engine 126 is configured to determine when the received condition implicates the purchase of the product 122a, based on the associated rule (from the stage profile for the product stage 124a). In cases where the replenishment engine 126 does not understand the received condition (e.g., the received condition is not consistent with the associated rule, the received condition is not clearly transmitted, etc.), the replenishment engine 126 may be configured to leave the condition as pending. In turn, when the replenishment engine 126 receives the next condition from the product stage 124a, it is configured to attempt to process all pending conditions together with the received condition (e.g., the replenishment engine 126 is configured to determine if the most recently received condition makes the previously received, and unprocessed, condition(s) from the product stage 124a moot; etc.). Then, after a defined interval (e.g., one day, two days, one week, etc.), when the replenishment engine 126 is still unable to understand a status of the stage 124a (and/or the corresponding product 122a) based on the received conditions, the replenishment engine 126 is configured to transmit a message to the consumer 112, at the replenishment application 128 of the communication device 114 (e.g., a push notification via Apple® Push Notification service (APNs), via Google® Cloud Messaging (GCM), etc.; etc.), thereby allowing the consumer 112 to take appropriate action.

In connection therewith, the replenishment engine 126 may update the product stage profile for the product stage 124a to maintain a record of usage data for the product 122a, based on events reported by the stage 124a (e.g., daily consumption in percentage, bad usage and/or out of position errors for the product 122a in relation to the stage 124a, communication errors and counts, etc.), etc.

When the replenishment engine 126 determines that the received condition implicates the purchase of the product 122a, the replenishment engine 126 is configured to facilitate a transaction for the purchase of the product 122a, consistent with the consumer 112 and/or the product stage profile for the product stage 124a, and/or transmit a notification to the consumer 112 via the replenishment application 128, at the communication device 114, with an option for the consumer 112 (or one of the other users invited for registration by the consumer 112 ) to purchase the product 122a via the replenishment engine 126 (as described herein).

In one example, the replenishment engine 126 may be configured to transmit a notification to the consumer 112 at the communication device 114, via the replenishment application 128, with a purchase list of products to be purchased in the transaction (including the product 122a and any other products identified by stages at the premises 116 as being requested for purchase). In turn, the consumer 112 is able to review and confirm the details of the purchase prior to approving the transaction (and/or potentially modify the details to add or remove products include in the purchase list). And, in connection with approving the transaction, the consumer 112 is able to select a desired payment method for the transaction (e.g., a payment method already established in a virtual wallet at the consumer's communication device 114, etc.). Then, to facilitate the transaction, in this example, the replenishment engine 126, or a part of the payment network 106, for example, is configured to transmit a payment credential (based on the desired payment method) to the merchant 102a (e.g., along path A in FIG. 1, etc.). In turn, the merchant 102a is configured to compile (e.g., based on the stage profile for the product stage 124a, etc.) and transmit an authorization request for the transaction to the issuer 108 (e.g., along path B in FIG. 1, etc.), whereby the issuer 108 is configured to determine whether the consumer's payment account is in good standing and whether there is sufficient funds and/or credit to cover the transaction, as is generally conventional. While the replenishment engine 126 provides the payment credential to the merchant 102a, in this example, it should be appreciated that in one or more other embodiments the replenishment engine 126 may itself initiate the transaction and/or provide the payment credential to other parts of the system 100 (which would then, in turn, initiate the transaction).

In another example, the consumer 112 may be enrolled (via a subscription, etc. facilitated through the replenishment engine 126 but supported by another part of the system (e.g., the payment network 106, etc.)) in an auto-replenishment service, in which case the replenishment engine 126 is configured to transmits a notification to a provider associated with the auto-replenishment service (e.g., merchant 102a, another provider associated with one of the other entities in the system 100 (e.g., the payment network 106, etc.) or separate therefrom, etc.) with a purchase list of products to be purchased in the transaction (including the product 122a and any other products identified by stages at the premises 116 as being requested for purchase). The provider may then generate an authorization request for the transaction, or at least facilitate the same with one or more associated merchants, etc.

In still another exemplary transaction for the product 122a, the replenishment engine 126, or a part of the payment network 106, for example, may be configured to compile (e.g., based on the stage profile for the product stage 124a, etc.) and transmit an authorization request for the transaction to the issuer 108 in order to determine whether the consumer's payment account is in good standing and whether there is sufficient funds and/or credit to cover the transaction, as is generally conventional.

In any case, once the transaction is completed, the product 122a is delivered by the merchant 102a, for example, to the consumer 112, at the premises 116 or otherwise, as indicated in the consumer and/or product stage profile (and as also potentially included in the authorization request for the transaction).

In the exemplary transactions herein, transaction data is generated, collected, and stored as part of the interactions among replenishment engine 126, the payment network 106, and the issuer 108 (and any other parts in the system 100 involved in the transactions). The transaction data relates to authorized transactions, cleared and/or settled transactions, attempted transactions, etc. The transaction data, in this exemplary embodiment, is stored at least by the payment network 106 and/or in the data structure 130, thereby providing access to the replenishments engine 126. In general, the transaction data may include, for example, PANs for payment accounts involved in the transactions, amounts of the transactions, product stage IDs, merchant IDs for merchants involved in the transactions, merchant category codes (MCCs), dates/times, products purchased and related descriptions or identifiers, etc. It should be appreciated that more or less information related to transactions, as part of either authorization or clearing and/or settling, may be included in transaction records and stored within the system 100, at the merchants 102a-b, the acquirer 104, the payment network 106 and/or the issuer 108.

In various exemplary embodiments, the consumers (e.g., consumer 112, etc.) involved in the different transactions herein are prompted to agree to legal terms associated with their payment accounts, for example, during enrollment in their accounts, during installation and/or activation of the replenishments application 128, etc. In so doing, the consumers may voluntarily agree, for example, to allow merchants, issuers, payment networks, others, etc., to use data collected during enrollment and/or collected in connection with processing the transactions, subsequently for one or more of the different purposes described herein.

Additionally, or alternatively, in the system 100, the replenishment engine 126, or other engine (not shown) associated with the payment network 106 may be configured to utilize such transaction data, for the consumer 112 and/or for other consumers, to compile offers for products (e.g., the products 122a-b, etc.) so that when a product is associated with one of the product stages 124a-c, the replenishment engine 126 and/or replenishment application 128, may be configured to provide offers to the consumer 112. In connection therewith, and to facilitate such offers, the consumer 112 is able not only to associate the products 122a-c with the product stages 124a-c, but also to identify the merchants 102a-b (e.g., via one or more parameters, etc.) as a desired merchant from which replenishment of one or more of the products 122a-c should be effected.

Moreover, the replenishment engine 126 (and/or the payment network 106) may be configured to score the consumer 112, for example, based on a number of the product stages 124a-c at the premises 116, based on a number of rules for the product stages 124a-c implementing automatic product purchases (e.g., purchases not requiring approval or additional action from the consumer 112 via auto-replenishment, etc.), based on a duration for which the consumer 112 is enrolled with the replenishment engine 126, based on a duration for which the consumer 112 is enrolled for automatic product purchases (e.g., auto-replenishment services, etc.), based on total spend by the consumer 112 using the product stages 124a-c (e.g., cumulative total spend, monthly total spend, etc.), based on total spend by the consumer 112 using automatic product purchases (e.g., cumulative total spend, monthly total spend, etc.), based on how long the consumer 112 has used the product stages 124a-c, based on a number of changes made to setups of the product stages 124a-c, based on a number of different products being purchased for various intervals (e.g., during a three month interval, during a six month interval, during the last year, etc.), based on consumer responses to prior marketing campaigns implemented by the replenishment engine 126 and/or the payment network 106, based on combinations thereof, etc. The replenishment engine 126 (and/or the payment network 106) may then be configured to weight the various different factors used to generate the score (e.g., such that the score is provided on a scale of 000 to 999, with the highest scores generally going to consumers that are relatively more stable and/or valuable; etc.), and provide the resulting score to the merchants 102a-b (and/or other merchants) for use in marking certain products (or the merchant's particular products, etc.), offers, etc. to the consumer 112, and/or utilize the score in other services offered through the payment network 106; etc.

The replenishment engine 126 (and/or the payment network 106) may also be configured to include information, patterns, etc. about the behavior of the consumer 112 in the consumer's profile. For example, the replenishment engine 126 (and/or the payment network 106) may be configured to store information regarding product setup and/or product stage setup, automatic purchase setup for products versus showing the products in a list option (i.e., versus the consumer 112 requiring approval for purchase of the products), how often the consumer 112 reconfigures the product stages 124a-c, how and/or what the consumer 112 names the product stages 124a-c, product misusage, etc. Additionally, or alternatively, such information may be included in the product stage profiles for the product stages 124a-c, whereby the information is used individually per product stage, rather than for all product stages (e.g., product stage 124a may be associated with an automatic purchase, while product stage 124b may require consumer permission, etc.).

In addition, the replenishment engine 126 (and/or the payment network 106) may be configured to store consumable information for the consumer 112, such as product consumption rate by season, month, day of the week, etc.; changes by the consumer 112 from one product to another product for the same one of the stages 124a-c; etc. In so doing, the consumer profile may then be used by the replenishment engine 126 (and/or the payment network 106), and/or may be made available to merchants 102a-b (and/or other merchants), to help enhance an experience of the consumer 112 with the product stages 124a-c and/or with purchasing products there through and/or with determining offers, products, etc. to market to the consumer 112; etc.

Further in the system 100, the product stages 124a-c, through use of the replenishment engine 126 and/or the replenishment application 128, may be subsequently associated with new and/or different products (i.e., other than the products 122a-c). As such, the replenishment engine 126 and/or the replenishment application 128, after associating the product stage 124a with the product 122a, for example, may be configured (or may configure the communication device 114 ) to disassociate the prior product 122a and then to solicit parameters related to a new product for association with the product stage 124a (e.g., to train the product stage 124a for the new product, etc.) (consistent with the description above and/or below).

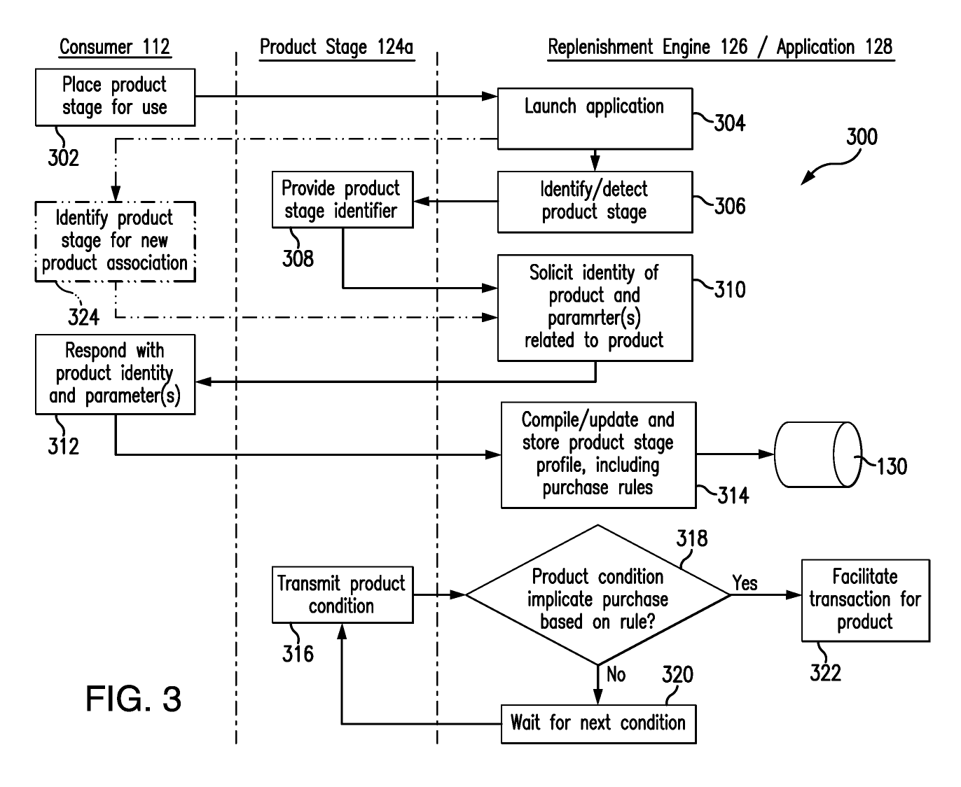

FIG. 3 illustrates an exemplary method 300 for use in facilitating a payment account transaction for a product based on one or more conditions of the product, for example, at a consumer's premises. The exemplary method 300 is described as implemented in the replenishment engine 126 and/or the replenishment application 128 of the system 100, with further reference to the consumer 112, the communication device 114, and the data structure 130. Reference is also made to the computing device 200. However, the methods herein should not be understood to be limited to the system 100 or the computing device 200, as the methods may be implemented in other systems and/or computing device. Likewise, the systems and the computing devices herein should not be understood to be limited to the exemplary method 300.

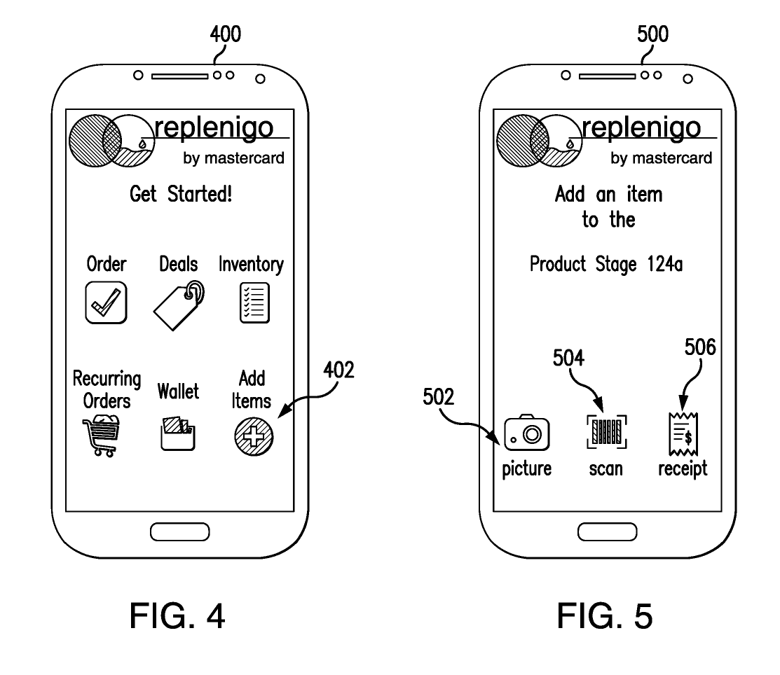

Furthermore, in explaining the method 300, it is assumed that the consumer 112 is registered to the replenishment engine 126 (as described above), such that a profile for the consumer 112 is included in the data structure 130. And, although already associated with the product 122a in the illustration of FIG. 1, the method 300 describes the registration of the product stage 124a for use with the product 122a and replenishment ordering of the product 122a. Nonetheless, it should be appreciated that the description, while directed to the product 122a and the product stage 124a, is applicable to the other products 122b-c and products stages 124b-c in the system 100, as well as to other products and other product stages in general. Further still, the method 300 is described with reference to exemplary interfaces 400-800 shown in FIGS. 4-8. It should be understood, however, that these interfaces 400-800 are merely exemplary in nature, and are provided for purposes of illustration and should not be understood to limit the systems or methods described herein.

At 302 in the method 300, the consumer 112 positions the product stage 124a within the laundry room 120, at the premises 116 (e.g., on a shelf, next to the washing machine, in a cabinet, above the washing machine, under a workbench. etc.). In doing so, the consumer 112 desires to assign the fabric softener product 122a to the product stage 124a. The consumer 112 then launches or otherwise accesses, at 304, the replenishment application 128, at the communication device 114. In response, the communication device 114 displays an interface to the consumer 112 to facilitate associating the product stage 124a with the replenishment application 128. The communication device 114 then identifies and/or detects, at 306, the product stage 124a (e.g., in response to the consumer 112 powering the product stage 124a, requesting to add the stage 124a at the communication device 114, or selecting an input on the product stage 124a, etc.). The communication device 114 then connects, via the network interface 210, with the product stage 124a (or vice-versa) (e.g., including an exchange of suitable credentials, as defined, or required; etc.), whereby the product stage 124a provides, at 308, at least one identifier associated therewith. For example, by its interaction with the network 118, the product stage 124a provides an identifier such as, for example, a network name, device ID, MAC address, etc., or combination thereof, which is visible by the communication device 114 (through connection to the same network 118, etc.). Additionally, or alternatively, the product stage 124a may transmit the identifier in response to a request and/or input to pair the product stage 124a with the communication device 114 (e.g., via a pairing button included in the product stage 124a, etc.), whereby the consumer 112 may then select the product stage 124a as appropriate and, if desired, assign a name to the product stage 124a.

FIG. 4 illustrates an exemplary interface 400 that may be displayed to the consumer 112 in connection with associating the product stage 124a with the communication device 114 and/or the replenishment application 128. In particular, the interface 400 permits the consumer 112 to select an “Add Item” button 402, which facilitates the addition (or pairing) of the corresponding product stage 124a. Here, with the desire to add the product stage 124a, the consumer 112 selects the button 402, whereupon the communication device 114 identifies and/or detects the product stage 124a (e.g., in response to the consumer 112 powering the product stage 124a, etc.).

Next in the method 300, once the product stage 124a is identified/detected, the communication device 114, as directed by the replenishment application 128 and/or the replenishment engine 126, solicits from the consumer 112, at 310, an identity of the product 122a to be associated with the product stage 124a and one or more parameters related to the product 122a. Thereafter, the consumer 112 responds, at 312, with the identity of the product 122a and one or more product parameters (broadly, provides one or more user inputs) to the communication device 114. For example, the consumer 112 may respond with an image of the product 122a (where the identity of the product 122a may then be determined by the replenishment engine 126 and/or replenishment application 128 via image analysis (e.g., a via cloud vision application programming interface (APIs) (e.g., Google® Cloud Vision API, etc.), etc.)), with a barcode or QR scan of the product 122a (where the identity of the product 122a may then be determined by the replenishment engine 126 and/or replenishment application 128 via the barcode), with a typed description of the product 122a, etc. And, the communication device 114, as directed by the replenishment application 128 and/or the replenishment engine 126, then identifies the product 122a and the one or more parameters and displays a confirmation to the consumer 112 that the product 122a is associated with the product stage 124a. The above process, at 310, can be repeated until all desired parameters for the product 122a are received.

The communication device 114 may also further display the particular product 122a associated with the product stage 124a, as well as any products associated with other ones of the product stages linked to the communication device 114 and the replenishment application 128 (e.g., products 122b-c and product stages 124b-c, etc.), permitting consumer to confirm.

FIG. 5 illustrates an exemplary interface 500 that may be displayed to the consumer 112 at the communication device 114 for use in associating the product 122a with the product stage 124a. As shown, the exemplary interface 500 identifies the “product stage 124a” and solicits the identity of the product 122a either by picture at 502, by scanning a barcode at 504, or by scanning a receipt at 506. While identified as “product stage 124a” in the interface 500, it should be appreciated that the product stage 124a may be identified differently in other interfaces (e.g., by other names and/or identifiers (e.g., by serial number, etc.), by markings unique and/or associated with the product stage 124a, etc.), whereby, for example, the consumer 112 would be able to visually verify which product stage is being identified by the communication device 114.

In response, the consumer 112 may select the option 502 in the interface 500 for taking a picture of the product 122a, and thereafter aim the camera input device 208 of the communication device 114 at the product 122a and capture the picture of the product 122a. Similarly, or alternatively, the consumer 112 may provide a response by selecting the barcode option 504 to scan a barcode of the product 122a, or by selecting the receipt option 506 to scan a receipt for the product 122a. If the latter receipt option 506 is selected, the consumer 112 may capture an indicia on the receipt for the product 122a (not shown), which provides product information for products purchased in a transaction to which the receipt relates (including the product 122a). In this option, the consumer 112 may further be solicited to select the particular product of interest (i.e., the product 122a) from a list of products included in the receipt. If the consumer 112 is unable to capture the product 122a by one or more of the above operations, the replenishment engine 126 and/or replenishment application 128 may prompt the consumer 112 to attempt to capture the product by another one of the available options, or cause a further interface to display at the communication device 114 to allow the consumer 112 to manually enter details for the product 122a (the replenishment engine 126 and/or replenishment application 128 may then attempt to associate the successful capture with the unsuccessful capture to thereby learn that the product 122a is associated with the unsuccessful capture). Regardless, in response to the imaged and/or scanned (or otherwise received) information, the replenishment engine 126 and/or replenishment application 128 identifies, or otherwise derives, the identity and/or parameters of the product 122a (e.g., via cloud vision APIs (e.g., Google® Cloud Vision API, etc.), etc.).

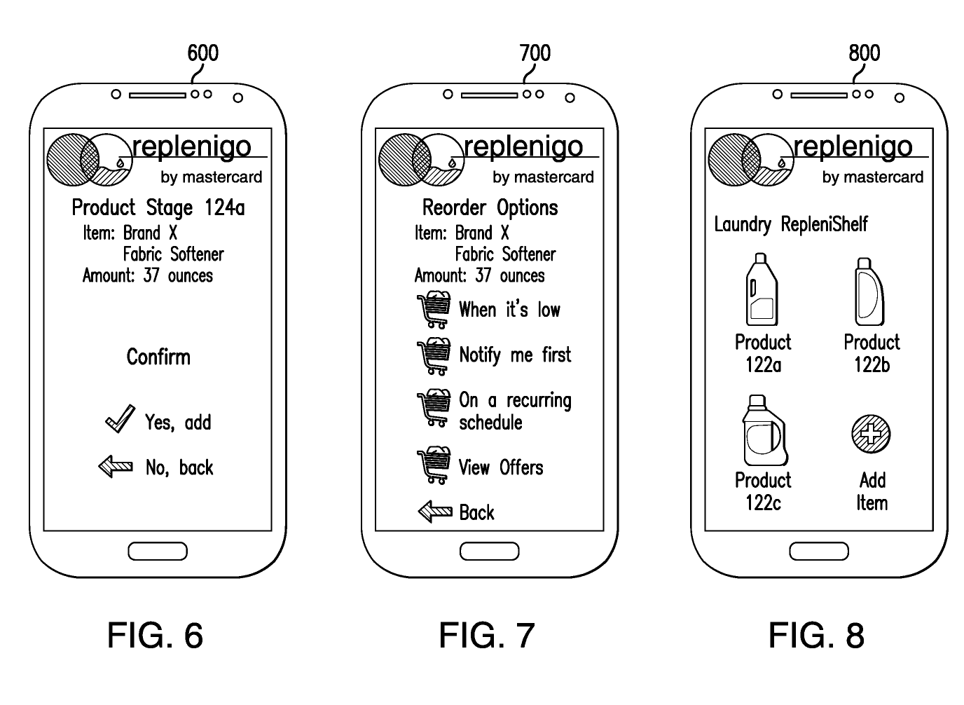

FIG. 6 illustrates an exemplary interface 600 that may be displayed to the consumer 112, at the communication device 114, upon identifying, or otherwise deriving the identity and/or parameters of, the product 122a for association with the product stage 124a (in response to the interface 500 ). As shown, the interface 600 recounts the detail of the product 122a, i.e., product name and brand (i.e., Brand X Fabric Softener), product size (i.e., 37 ounces), etc. If correct, the consumer 112 may select the “Yes, add” input (broadly, provides a user input) to confirm the product 122a, and thereby associating the product 122a with the product stage 124a.

FIG. 7 illustrates a further exemplary interface 700 that may be displayed to the consumer 112, at the communication device 114, for use in soliciting parameters (e.g., at 310 in the method 300, etc.) relating to the product 122a. As shown, the interface 700 solicits a parameter (e.g., a selection of an illustrated option, etc.), which may subsequently be used in compiling the product stage profile and/or rules therein for the product stage 124a (as described below). Here, the example parameters relate to the purchase of a replenishment product 122a “When it's low” (e.g., an automatic purchase of the product 122a, etc.). Additional parameters in the interface 700 relate to rules for notifying the consumer 112 prior to performing a purchase transaction for the product 122a (i.e., “Notify me first”), and to rules indicating a recurring purchase based on time/interval (broadly, on a schedule) (i.e., “On a recurring schedule”). The interface 700 further includes an option for the consumer 112 to “View Offers,” whereby offers related to the product 122a may be displayed to the consumer 112.

With that said, in the interface 700, when the “When it's low” parameter is selected, the communication device 114 may further, if not already done, solicit a parameter upon which a rule associated with “When it's low” may be compiled. For example, as described above, the consumer 112 may be invited to place a new product 122a on the product stage 124a so that a baseline condition may be captured for the product 122a, where the baseline condition is a parameter of the product 122a. The consumer 112 may then be solicited to enter a percentage (e.g., when 10% remains, etc.) (or other value) upon which the rule related to replenishment of the product 122a may be compiled. It should be appreciated that various other parameters may be solicited from the consumer 112 and/or the product stage 124a to determine whether the product 122a is “low” or otherwise ready for replenishment. That said, it should also be appreciated that certain parameters may be predefined (e.g., 10% remaining, etc.), such that not all parameters are solicited from the consumer 112.

And, FIG. 8 illustrates an interface 800 that may be displayed to the consumer 112, at the communication device 114, when the consumer 112 responds with the further parameters in interface 700. Through the interface 800, the consumer 112 is able to view all of the products 122a-b associated with products stages 124a-c at the premises 116. In particular, the interface 800 indicates that the consumer 112 has now associated the fabric softener product 122a, the stain remover product 122b, and the detergent product 122c to product stages 124a-c in the premises 116.

It should be appreciated that various different sequences of interfaces and/or user inputs may be provided by the replenishment application 128 and/or the replenishment engine 126 (e.g., via the communication device 114, etc.) to solicit one or more parameters related to products and then to allow responses with the solicited parameters. For example, when the product 122a is identified, the replenishment engine 126 and/or replenishments application 128 may return potential merchants 102a-b for purchase of the product 122a (for selection by the consumer 112) and/or pricing associated therewith. In this way, the merchant (broadly, a parameter) is solicited and may be selected from a predefined list of merchants. Additionally, or alternatively, one or more merchants may be a default merchant (which is selected in the absence of a consumer input), or the consumer may enter a particular merchant.

With reference again to FIG. 3, once the parameters, as needed, or desired, are provided, the replenishment engine 126 compiles, at 314, a product stage profile for the product stage 124a, which includes, for example, an identifier of the product stage 124a (e.g., by MAC address, name, designation, etc.), data related to the product 122a associated with the product stage 124a, and rules associated with purchasing a replenishment product (e.g., when the product 122a is low, etc.). In this example, the product 122a is the fabric softener product, which is 37 ounces in size (corresponding to a product weight of 4.8 lbs.) (all broadly parameters of the product). The product stage profile, which identifies the product, may further identify a threshold parameter of 0.8 lbs. as being “when it's low” for the 37 ounce fabric softener. That is, in compiling the profile, the replenishment engine 126 compiles one or more replenishment rules associated with the product stage 124a, which are indicative of when to facilitate a purchase transaction for the product 122a (with or without notification to the consumer 112). For example, in view of the parameters above, the replenishment engine 126 compiles a rule (or preference) to facilitate a product purchase automatically when the product weight of the fabric softer (broadly, the condition) is 0.8 lbs. (i.e., when the product is considered to be “low”). Upon compilation of the product stage profile, then, the replenishment engine 126 stores the profile in the data structure 130, in association with the profile of the consumer 112 (e.g., by linking a customer identifier for the customer 112, with an item identifier for the product 122a, and/or with a stage identifier for the stage 124a, and/or with a stage location identifier, etc.), or within the consumer's profile. By associating or including the product stage profile with/in the consumer profile, the replenishment engine 126 identifies the payment account, from the consumer profile, as the payment account through which the replenishment products are to be purchased. Table 1 includes various exemplary rules/preferences that may be compiled to facilitate a product purchase.

TABLE 1

| Condition | Action |
|---|---|
| If fabric softener product 122a is below | Then request confirmation from |
| 8 ounces | consumer 112 to purchase 130 |
| | ounce Brand X fabric softener |
| If stain remover product 122b is below | Then automatically purchase 12 |
| 4 ounces | ounce Brand Y stain remover |
| | product |
| If detergent product 122c is below | Then automatically purchase 100 |
| 8 ounces | ounce Brand Z detergent |

In addition, in certain embodiments where the product stages 124b-c are subordinate product stages to the master product stage 124a, for example, the communication device 114, as directed by the replenishment application 128 and/or the replenishment engine 126, may communicate with the subordinate product stages 124b-c by and/or through the product stage 124a. In such embodiments, at operations 306/308, the subordinate product stages 124b-c will be identified not only by an identifier associated therewith, but also by an identifier associated with the master product stage 124a. Subsequent communications to/from the subordinate product stages 124b-c, then, will include both identifiers thereby indicating to the master product stage 124a, the replenishment engine 126 and/or the replenishment application 128 to what product stage 124a-c the conditions being reported are related (as described below), as well as associating the specified product 122a-c with the proper product stage 124a-c.

Separately in the method 300, once the products 122a-b, in this example, are associated with the product stages 124a-c, the product stages 124a-c each (or via the master product stage 124a, when such an arrangement is implemented) transmit, at 316, one or more product conditions for the products 122a-c to the replenishment engine 126, via the network 118 and/or the network 110. For example, the product stage 124a may transmit a message to the replenishment engine 126, where the message includes at least an identifier of the product stage 124a and the condition of the product 122a.

When the product condition is received at the replenishment engine 126, the replenishment engine 126 determines, at 318, whether the condition implicates purchase of the associated product based on one or more rules for the product stage 124a (e.g., as provided by the consumer 112 and stored in the product stage profile for the product stage 124a, etc.). For example, when the condition of the fabric softener product 122a is 2.1 lbs., the replenishment engine 126 waits, at 320, for addition transmitted conditions to be received from the product stage 124a for the product 122a. Subsequently, the product stage 124a transmits a new condition indicating a weight of 0.6 lbs. for the product 122a. In this instance, as indicated in the product stage profile for the product stage 124a, this condition falls below the 0.8 lbs. threshold, such that, at 318, the replenishment engine 126 determines that a purchase of the product 122a should be implemented. As such, the replenishment engine 126 facilitates, at 322, a purchase transaction for the product 122a, as described above (via the consumer's payment account included in the consumer's profile) (e.g., by communication with the consumer 112, the merchant 102a/b, the issuer 108, etc.).

As also shown in FIG. 3, the method 300 optionally (as indicated by the broken lines) provides the consumer 112 with the ability to change the product associated with the one or more of the stages 124a-c. For example, the consumer 112 may decide to associate the product stage 124b with a different stain remover product 122b, or even to associate the product stage 124b with a different product all together (e.g., a dryer sheet product in the laundry room 120 of the premises 116, or a dog food product in a mudroom at the premises 116, etc.). To do so, after launching the replenishment application 128, at 304, the consumer 112 identifies, at 324, the particular product stage (e.g., the product stage 124b, etc.) for association with a new product (broadly, through a user input). For example, the consumer 112 may select the product stage 124b, for example, from interface 800, from which an option to “name a different product” may then be provided to the consumer 112. Subsequently, the method 300 continues to solicit one or more parameters from the consumer 112 related to the new product, at 310, to which the consumer responds, at 312, thereby permitting the replenishment engine 126 to update, at 314, the product stage profile based on the new product.

In view of the above, the systems and methods herein provide customizable replenishments at the consumer's premises, through use of product stages, which are registered to the consumer and associated with particular products. The product stages, or the replenishment application and/or replenishment engine associated therewith, determine when a replenished product should be purchased (by rules set, at least in part, by the consumer's inputs), so that the product is available for use by the consumer, generally, when needed. That is, the systems and methods herein seek to avoid full depletion of products associated with the product stages, by purchasing replenishment products, as needed, based on the condition of the product, as determined by the product stages. In this manner, the decisions associated with replenishing products are set, at the outset, and then executed automatically (or at least partially automatically, depending on the rules involved). Further, the use of the stages avoid reliance on the particular devices utilizing the products to make such a determination. For example, a device does not always have the ability to determine the usage of a product, and then also have the capabilities to communicate with the product usage (e.g., the printer and ink cartridge example, etc.). The systems and methods herein thus have the ability to permit an automatic (or semi-automatic), efficient, and/or flexible condition evaluation solution, whereby a number products, which may or may not be related and/or have limited relation to technology (i.e., virtually any product products), may be equipped with the technology described herein to account for replenishment of the same.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) identifying a product stage; (b) soliciting, from a consumer associated with the product stage, an identity of a product to be associated with the product stage and at least one parameter of said product; (c) receiving the identity of the product and the at least one parameter of said product; (d) compiling, by the computing device, a product stage profile for the product stage, the product stage profile including an identifier of the product stage, the identity of the product, the at least one parameter of said product, and at least one replenishment rule for the product based on the at least one parameter; (e) receiving a message from the product stage, the message including the identifier of the product stage and a condition of the product associated with the product stage at a premises; (f) retrieving the at least one replenishment rule based on the identity of the product stage; (g) determining whether a product purchase is implicated by the condition, based on the at least one replenishment rule; and (h) facilitating a transaction for purchase of the product from a merchant.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for facilitating payment account transactions for products based on conditions associated with the products, thereby allowing replenishment of the products, the method comprising:
identifying a product stage;
soliciting, from a consumer associated with the product stage, an identity of a product to be associated with the product stage and at least one parameter of said product;
receiving, at a computing device, the identity of the product and the at least one parameter of said product;
compiling, by the computing device, a product stage profile for the product stage, the product stage profile including an identifier of the product stage, the identity of the product, the at least one parameter of said product, and at least one replenishment rule for the product based on the at least one parameter;
receiving, at the computing device, a message from the product stage, the message including the identifier of the product stage and a condition of the product associated with the product stage at a premises;
retrieving, by the computing device, the at least one replenishment rule based on the identity of the product stage;
determining, by the computing device, whether a product purchase is implicated by the condition, based on the at least one replenishment rule; and
facilitating a transaction for purchase of the product from a merchant.

2. The computer-implemented method of claim 1, wherein the product stage includes at least one weight sensor; and
wherein the condition of the product includes a weight of the product.

3. The computer-implemented method of claim 1, wherein soliciting the identity of the product and the at least one parameter of said product includes soliciting an image of at least a portion of the product, whereby the identity of the product and the at least one parameter are derived from the image.

4. The computer-implemented method of claim 1, further comprising:
soliciting a user selection, at a communication device, of the at least one replenishment rule for the product; and
assigning a threshold to the at least one replenishment rule, based at least partly on the at least one parameter, such that when the condition, received form the product stage, is below the threshold, the product purchase is implicated.

5. The computer-implemented method of claim 4, wherein the at least one parameter includes a product size associated with the product.

6. The computer-implemented method of claim 1, further comprising:
receiving an identity of a different product for said product stage; and
updating, by the computing device, the product stage profile to include the identity of the different product and at least one replenishment rule associated with the different product.

7. The computer-implemented method of claim 1, further comprising soliciting, by the at least one computing device, a permission for purchase of the product; and
wherein facilitating the transaction for the purchase of the product includes facilitating the transaction for the purchase of the product only after the permission is received.

8. The computer-implemented method of claim 1, wherein soliciting the identity of the product includes soliciting, at a communication device associated with the consumer, the identity of the product.

9. A system for use in facilitating payment account transactions, the system comprising:
a computing device including a memory, the memory including a product stage profile, the product stage profile including a product stage identifier and at least one replenishment rule; and
at least one product stage in communication with the computing device, the at least one product stage associated with the product stage identifier included in the product stage profile;
wherein the at least one product stage is configured to sense a condition of a product associated therewith and transmit a message to the computing device regarding the condition, the message including the product stage identifier and the condition;
wherein the computing device is configured to:
determine whether a product purchase is implicated by the condition of the product, based on the at least one replenishment rule; and
facilitate a transaction for purchase of the product from a merchant when the product purchase is implicated.

10. The system of claim 9, wherein the at least one product stage is further configured to transmit a pairing message comprising the product stage identifier in response to an input to pair the at least one product stage with the computing device.

11. The system of claim 9, wherein the computing device is configured to:
solicit, from a consumer, an identity of the product, prior to the product being associated with the at least one product stage, and at least one parameter of said product;
receive the product stage identifier for the at least one product stage, the identity of the product, and the at least one parameter of said product from the consumer; and
compile and store the product stage profile for the at least one product stage in the memory, based on the product stage identifier for the at least one product stage, the identity of the product, the at least one parameter of said product, and the at least one replenishment rule for the product.

12. The system of claim 11, wherein the computing device is further configured to:
receive the product stage identifier for the at least one product stage, the identity of a different product, and at least one parameter of said different product; and
update and store the product stage profile for the at least one product stage in the memory, based on the product stage identifier for the at least one product stage, the identity of the different product, and the at least one parameter of said different product.

13. The system of claim 9, wherein the at least one product stage includes at least one weight sensor; and
wherein the condition of the product includes a weight of the product.

14. The system of claim 13, wherein the at least one product stage includes a master product stage and a servant product stage;
wherein the servant product stage is configured to sense a condition of a product associated therewith and transmit a servant message to the master product stage; and
wherein the master product stage is configured to transmit the servant message to the computing device.

15. The system of claim 9, wherein the computing device is configured to solicit a permission for purchase of the product prior to facilitating the transaction for purchase of the product from the merchant.

16. The system of claim 15, wherein the computing device includes a communication device associated with a consumer; and
wherein the communication device is configured to provide a payment account credential to the merchant in order to facilitate the transaction for purchase of the product from the merchant.

17. A non-transitory computer-readable storage media comprising executable instructions for use in facilitating a payment account transaction which, when executed by at least one processor, cause the at least one processor to:
receive an identifier of a product stage at a premises, an identity of a product associated with the product stage, and at least one parameter of the product;
compile a product stage profile for the product stage, the product stage profile including the identifier of the product stage, the identity of the product, the at least one parameter of said product, and at least one replenishment rule for the product based on the at least one parameter;
receive a message from the product stage, the message including the identifier of the product stage and a measured condition of the product associated with the product stage; and
facilitate a transaction for purchase of the product from a merchant when the measured condition of the product associated with the product stage satisfies the at least one replenishment rule for the product.

18. The non-transitory computer-readable storage media of claim 17, wherein the executable instructions, when executed by the at least one processor, further cause the at least one processor to:
receive the identifier of the product stage, an identity of a different product associated with the product stage, and at least one parameter of the different product; and
update the product stage profile for the product stage, the updated product stage profile including the identifier of the product stage, the identity of the different product, the at least one parameter of said different product, and at least one replenishment rule for the different product based on the at least one parameter, thereby disassociating the product from the product stage and associating the different product with the product stage.

19. The non-transitory computer-readable storage media of claim 17, wherein the executable instructions, when executed by the at least one processor, further cause the at least one processor to:
solicit and receive a permission for purchase of the product prior to facilitating the transaction for purchase of the product from the merchant; and
provide a payment account credential to the merchant, thereby facilitating the transaction for purchase of the product.

20. The non-transitory computer-readable storage media of claim 19, wherein the executable instructions, when executed by the at least one processor, further cause the at least one processor to:
solicit a user selection of the at least one replenishment rule for the product; and
assign a threshold to the at least one replenishment rule based at least partly on a baseline condition of the product received from the product stage, such that the at least one replenishment rule is satisfied when the measured condition of the product is below the threshold.
